(19) United States
(12) Patent Application Publication
(10) Pub. No.: US 2024/0058201 A1
(43) Pub. Date: Feb. 22, 2024

(54) SEAT MASSAGE SYSTEM AND VEHICLE EQUIPPED WITH THE SAME

(71) Applicants: Hyundai Motor Company, Seoul (KR); Kia Corporation, Seoul (KR); Faurecia (China) Holding Co., Ltd., Shanghai (CN)

(72) Inventors: Ming LI, Shandong (KR); Hai Yan ZHAO, Shandong (KR); Joo Hwan SON, Anyang-Si (KR); Heng ZI, Shanghai (CN); Wei LUO, Shanghai (CN); Wei TAO, Shanghai (CN)

(73) Assignees: Hyundai Motor Company, Seoul (KR); Kia Corporation, Seoul (KR); Faurecia (China) Holding Co., Ltd., Shanghai (CN)

(21) Appl. No.: 18/072,341

(22) Filed: Nov. 30, 2022

(30) Foreign Application Priority Data
Aug. 16, 2022 (CN) 202210981236.2

(51) Int. Cl. A61H 7/00; B60N 2/90

(52) U.S. Cl. CPC A61H 7/001; B60N 2/976; A61H 2201/1669; A61H 2201/1671; A61H 2201/5058; A61H 2201/1454; A61H 2201/1695; A61H 2201/1463; A61H 2201/0149

(57) ABSTRACT

A seat massage system includes a substrate; a driving assembly, a power delivery assembly; a rail base including a guide groove provided on an internal surface, the guide groove including a first portion close to the substrate and a second portion farther from the substrate; a moving base provided on the corresponding one rail base, receiving driving force from a corresponding power delivery assembly, provided with a guide member, and sliding along the guide groove; and a massage head member provided at a front end of the moving base, where the power delivery assembly drives the corresponding moving base to rotate relative to the rail base by the driving of the drive assembly, and at the same time causes the moving base to linearly move in forward and rearward direction through coupling of the guide member and the guide groove, and controls to control the moving base to stop at a predetermined position.

### CROSS-REFERENCE TO RELATED APPLICATION

The present application claims priority to Chinese Patent Application No. 202210981236.2 filed in the Chinese National Intellectual Property Administration on Aug. 16, 2022, the entire contents of which is incorporated herein for all purposes by this reference.

### BACKGROUND OF THE PRESENT DISCLOSURE

### Field of the Present Disclosure

The present disclosure relates to a vehicle field, and more particularly, to a seat massage system and a vehicle provided with the seat massage system.

### Description of Related Art

Currently, some vehicles include a massage device mounted to the seatback to massage a waist and/or a back with the massage device, reducing fatigue of a driver and occupants.

Most vehicle seats on the market mainly use a pneumatic massage system. In the present structure, the massage is performed through inflating and deflating an airbag, so there is no rotation function and the elasticity is small, and thus the massage effect is not good.

Therefore, there is a need to further improve the massage device of the vehicle seat in the related art.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a seat massage system and a vehicle provided with the seat massage system having advantages of implementing a massage function by driving a corresponding moving base and a massage head member to rotate and linearly move in a forward and rearward direction by use of a driving assembly.

Various aspects of the present disclosure are directed to providing a seat massage system including: a substrate configured to be mounted on a seatback frame; at least one drive assembly mounted on the substrate; at least one power delivery assembly mounted on the substrate and receiving driving force from a corresponding driving assembly; at least one rail base mounted on the substrate and including a guide groove provided on an internal surface of the rail base, the guide groove including a first portion close to the substrate and a second portion farther from the substrate; at least one moving base, each being provided on the corresponding rail base to receive driving force from the corresponding power delivery assembly, and provided with a guide member corresponding to the guide groove of the rail base, the guide member extending into the guide groove and sliding along the guide groove; and at least one massage head member provided at a front end portion of a corresponding moving base, in which the power delivery assembly drives the corresponding moving base to rotate relative to the rail base by the driving of the drive assembly, and at the same time causes the moving base to linearly move in a forward and rearward direction through coupling of the guide member and the guide groove, and controls the moving base to stop at a predetermined position thereof.

A sensor may be provided on one of the rail base and the corresponding moving base, and a magnetic member matching the sensor is provided on another of the rail base and the corresponding moving base, and the magnetic member may be aligned with the sensor when the guide member slides along the guide groove to a closest portion of the guide groove closest to the substrate and/or a remotest portion of the guide groove farthest from the substrate.

The seat massage system may further include a controller, in which when the magnetic member is aligned with the sensor, the sensor generates a trigger signal and sends the trigger signal to the controller, and the controller may be configured to control the corresponding driving assembly according to the trigger signal to stop the moving base and the massage head member at predetermined positions.

The guide groove has a shape of closed loop.

At least one elastic member is provided between the moving base and the corresponding massage head member.

A fixing groove is provided on an external circumferential surface of the moving base, and the guide member is mounted in a corresponding fixing groove through a fixing pin and a fixing wedge.

The guide member includes: a bearing mounted in the fixing groove; and a rotation shaft mounted on an internal ring of the bearing and rotating relative to the bearing.

The moving base is provided with a mounting groove toward the massage head member, a first end portion of the at least one elastic member is connected to a bottom wall of the corresponding mounting groove, and a second end portion of the at least one elastic member is connected to the corresponding massage head member.

At least one sliding groove toward the massage head member is provided on the moving base.

The massage head member includes: a massage head member main body; an insertion connecting member which extends from the massage head member main body toward one side close to the substrate, and allowing the massage head member main body to linearly move in the forward and rearward direction with respect to the moving base, the massage head member main body being mounted to the moving base so that the insertion connecting member is inserted into the corresponding sliding groove and linearly moves in the forward and rearward direction along the sliding groove; and a protrusion protruding from the massage head member main body toward one side far away from the substrate.

A felt is provided between the massage head member main body and the moving base.

The power delivery assembly includes: a driving rod including a first end portion pivotably connected to the substrate and a second end portion connected to the corresponding driving assembly; a driving gear provided on the driving rod and being rotatable according to a rotation of the driving rod; an idler pivotally connected to the substrate and meshed with the driving gear; a transmission shaft including a first end portion pivotably connected to the substrate and a second end portion connected to the corresponding moving base; and a driven gear provided on the transmission shaft and meshed with the idler, the transmission shaft being rotatable according to a rotation of the driven gear.

The transmission shaft includes a front extension portion and a rear extension portion connected to each other, the rear extension portion is pivotally connected to the substrate, and the driven gear is provided between the front extension portion and the rear extension portion.

The moving base is provided with a receiving chamber facing the substrate corresponding to the transmission shaft, a lug is provided on one of an external circumferential surface of the front extension portion and an internal circumferential surface of the receiving chamber, and a strip-shaped groove that extends in the forward and rearward direction and matches the lug is provided on the other of the external circumferential surface of the front extension portion and the internal circumferential surface of the receiving chamber, and the lug extends into the corresponding strip-shaped groove to cause the transmission shaft to rotatably drive the moving base, and the lug slides in the forward and rearward direction along the corresponding strip-shaped groove so that the moving base linearly moves in the forward and rearward direction thereof.

Various aspects of the present disclosure are directed to providing a vehicle provided with the seat massage system according to the exemplary embodiment of the present disclosure.

According to an exemplary embodiment of the present disclosure, the seat massage system implements a massage function by driving the corresponding moving base and the massage head member to rotate and linearly move in the forward and rearward direction by use of the driving assembly.

The method and apparatus of the present disclosure have other characteristics and advantages, and these characteristics and advantages will become apparent from the accompanying drawings and the following exemplary embodiments in the text, or will be described in detail in the drawings attached to the text and the exemplary embodiments to be described later, and both these drawings and exemplary embodiments are intended to interpret certain principles of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of a seat massage system according to various exemplary embodiments of the present disclosure.

FIG. 2 is a schematic diagram illustrating a structure of a seat massage system according to various exemplary embodiments of the present disclosure.

FIG. 3 is an exploded perspective view of FIG. 2.

FIG. 4 is a front view of a seat massage system.

FIG. 5 is a cross-sectional view taken along a line A-A in FIG. 4.

FIG. 6 is a schematic view exemplarily illustrating a structure of a rail base.

FIG. 7 is a schematic diagram illustrating a structure of a moving base.

FIG. 8 is a schematic diagram illustrating a structure of a guide member.

FIG. 9 is an enlarged view of a portion in FIG. 6.

FIG. 10 is a side view of a seat massage system.

FIG. 11 is another front view of a seat massage system.

FIG. 12 is another side view of a seat massage system.

FIG. 13 is another front view of a seat massage system.

FIG. 14 is a schematic diagram of a seat massage system according to various exemplary embodiments of the present disclosure.

FIG. 15 is a cross-sectional view taken along a line B-B in FIG. 4.

FIG. 16 is a schematic diagram illustrating a coupling of a transmission shaft and a receiving chamber.

It should be understood that the drawings simply illustrate features to explain the basic principles of the present disclosure, and are not necessarily drawn to scale. Specific design features disclosed in an exemplary embodiment of the present disclosure (including, for example, specific sizes, directions, positions, and shapes) are specifically determined in part according to applications and environments in which an exemplary embodiment of the present disclosure will be used.

In these drawings, the same reference numbers throughout the plurality of drawings indicate the same or equivalent parts of the present disclosure.

### DETAILED DESCRIPTION

Hereinafter, with reference to various exemplary embodiments of the present disclosure in detail, these exemplary embodiments will be described below by exemplifying the exemplary embodiments in the drawings. Although the present disclosure has been described in conjunction with exemplary embodiments of the present disclosure, it is to be understood that the present specification is not intended to limit the present disclosure to these exemplary embodiments of the present disclosure. To the contrary, the present disclosure not only includes these exemplary embodiments of the present disclosure, but also includes various alternatives, modifications, equivalents, and other exemplary embodiments within the scope of the spirit of the present disclosure and the appended claims.

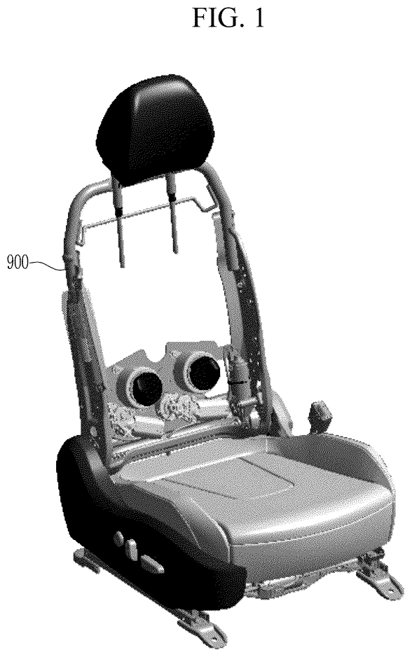

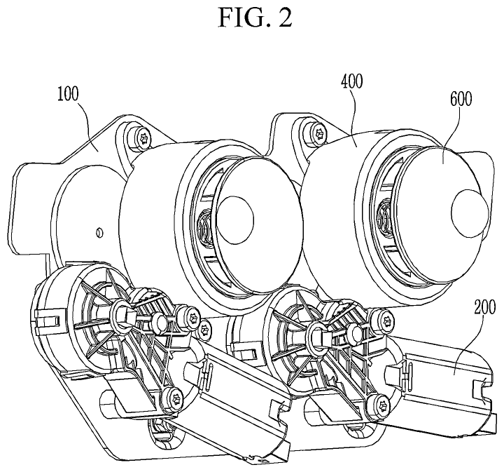

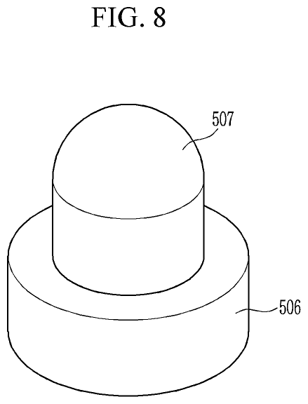

Hereinafter, a seat massage system according to various exemplary embodiments of the present disclosure will be described referring to FIGS. 1 to 16.

In the present specification, a ‘front end’ means a front end portion of a vehicle, and a ‘rear end’ means a rear end portion of the vehicle.

As illustrated in FIGS. 1 to 16, a seat massage system according to various exemplary embodiments of the present disclosure includes a substrate 100, at least one driving assembly 200, at least one power delivery assembly 300, and at least one rail base 400, at least one moving base 500, and at least one massage head member 600.

The substrate 100 is mounted on a seatback frame 900.

The driving assembly 200 is mounted on the substrate 100, and the driving assembly 200 provides driving force.

The power delivery assembly 300 is mounted on the substrate 100 and receives the driving force from the corresponding driving assembly 200. The number of the power delivery assemblies 300 corresponds to the number of the drive assemblies 200.

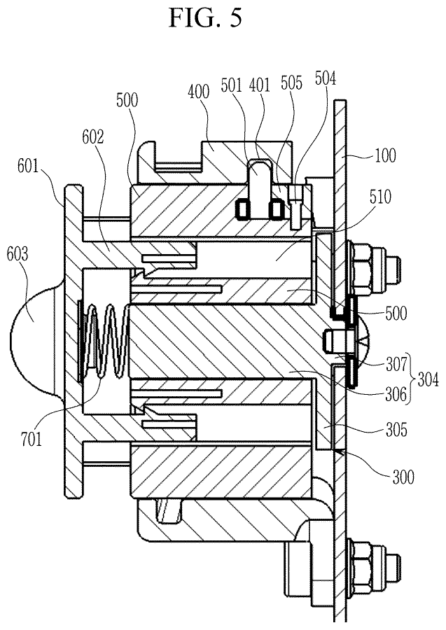

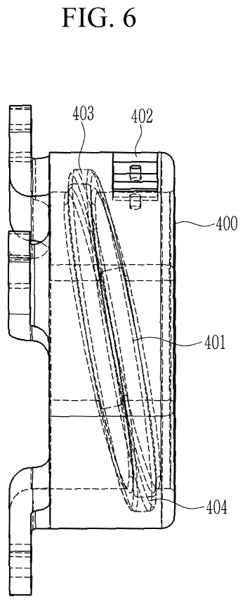

The rail base 400 is mounted on the substrate 100, and a guide groove 401 is provided on an internal surface of the rail base 400 (see FIG. 5 and FIG. 6) and has a portion close to the substrate 100 (a portion farther from a human body) and a portion farther from the substrate 100 (a portion close to the human body). The number of the rail bases 400 corresponds to the number of the power delivery assemblies 300.

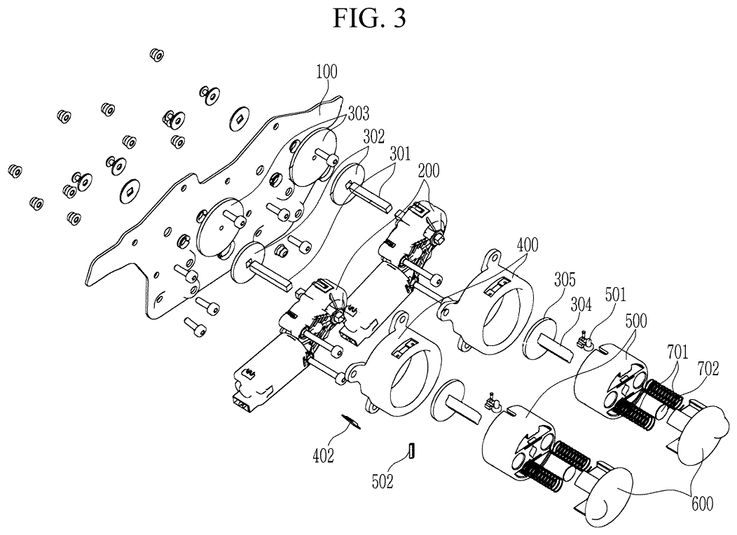

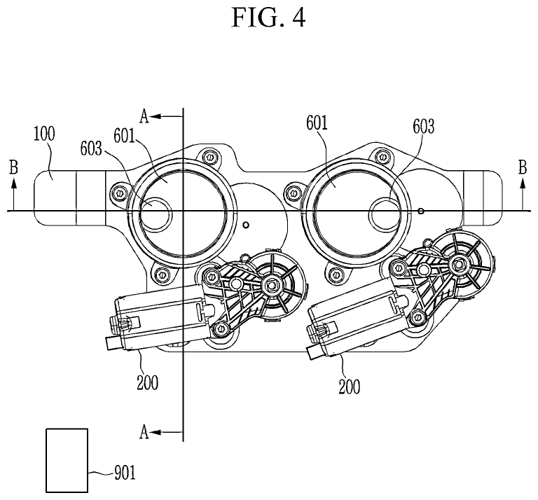

The number of the moving bases 500 corresponds to the number of the rail bases 400, each moving base 500 is provided on the corresponding rail base 400 and receives the driving force from the corresponding power delivery assembly 300, the moving base 500 is provided with a guide member 501 corresponding to the guide groove 401 of the rail base 400, and the guide member 501 may extend into the guide groove 401 and slide along the guide groove 401 (see FIG. 3, FIG. 4, FIG. 5 and FIG. 6).

The number of the massage head members 600 corresponds to the number of the rail bases 400, and each massage head member 600 is provided at a front end portion of a corresponding moving base 500 (see FIGS. 3 and 5).

The power delivery assembly 300 drives the corresponding moving base 500 to rotate relative to the rail base 400 by driving of the driving assembly 200, and at the same time linearly moves the moving base 500 forwardly and backwardly through coupling of the guide member 501 and the guide groove 401, implementing a massage function.

Here, the moving base 500 is controlled to stop at a predetermined position, implementing a support function.

Because the driving assembly 200, the power delivery assembly 300, the rail base 400, the moving base 500, and the massage head member 600 have a one-to-one correspondence, when a plurality of massage head members 600 is provided, the plurality of drive assemblies 200 is controlled through a controller 901 to control the plurality of massage head members 600, respectively, and this allows the plurality of massage head members 600 to operate asynchronously, providing a variety of massage modes.

In the exemplary embodiment of the present disclosure, a sensor 402 is provided on one of the rail base 400 and the corresponding moving base 500, and a magnetic member 502 matching the sensor 402 is provided on the other of the rail base 400 and the corresponding moving base 500.

When the guide member 501 slides to a closest portion 403 of the guide groove 401 closest to the substrate 100 (that is, a portion farthest from the human body) and/or a remotest portion 404 of the guide groove 401 farthest from the substrate 100 (that is, a portion closest to the human body) along the guide groove 401, the magnetic member 502 is aligned with the sensor 402.

In an exemplary embodiment exemplary embodiment of the present disclosure, the sensor 402 is provided on the rail base 400, and the magnetic member 502 matching the sensor 402 is provided on the moving base 500.

When the guide member 501 slides along the guide groove 401 to the remotest portion 404 of the guide groove 401 (that is, the portion closest to the human body) farthest from the substrate 100, the magnetic member 502 is aligned with the sensor 402, and the sensor 402 detects the magnetic member 502 to generate a trigger signal.

In another exemplary embodiment of the present disclosure, when the guide member 501 slides along the guide groove 401 to the closest portion 403 of the guide groove 401 closest to the substrate 100 (that is, the portion farthest to the human body), the magnetic member 502 is aligned with the sensor 402, and the sensor 402 detects the magnetic member 502 to generate a trigger signal.

In another exemplary embodiment of the present disclosure, the sensor is provided on the moving base 500, and the magnetic member matching the sensor is provided on the rail base 400.

In an exemplary embodiment of the present disclosure, the seat massage system further includes the controller 901.

When the magnetic member 502 is aligned with the sensor 402, the sensor 402 may generate the trigger signal and send the trigger signal to the controller 901, and the controller 901 may control the corresponding driving assembly 200 according to the trigger signal to stop the moving base 500 and the massage head member 600 at predetermined positions.

In an exemplary embodiment exemplary embodiment of the present disclosure, the sensor 402 is provided on the rail base 400, and the magnetic member 502 matching the sensor 402 is provided on the moving base 500. When the guide member 501 slides along the guide groove 401 to the remotest portion 404 of the guide groove 401 farthest from the substrate 100 (that is, the portion closest to the human body), the magnetic member 502 is aligned with the sensor 402, and the sensor 402 detects the magnetic member 502 to generate the trigger signal.

The magnetic member 502 sends the trigger signal to the controller 901, and the controller 901 is configured to control the corresponding driving assembly 200 according to the trigger signal, to further rotate the moving base 500 and the massage head member 600 by 180 degrees. After the moving base 500 and the massage head member 600 further rotate by 180 degrees, the controller 901 stops the guide member 501 at the closest portion 403 of the guide groove 401 closest to the substrate 100 (that is, the portion farthest from the human body) by stopping the rotation of the moving base 500 and the massage head member 600, so that the controller 901 may further control the moving base 500 and the massage head member 600 to stop at the portion farthest from the human body (that is, the initial position).

In the case where it is desired to stop the moving base 500 and the massage head member 600 at another predetermined position, a rotation angle corresponding to the predetermined position is determined in advance, and the corresponding rotation angle is stored only in advance in the controller 901. Therefore, the moving base 500 and the massage head member 600 may be controlled to stop at the predetermined position thereof.

In the exemplary embodiment of the present disclosure, the controller 901 may be integrated into a console of the vehicle.

In the exemplary embodiment of the present disclosure, the driving assembly 200 may be a motor, and a type of the driving assembly 200 is not limited thereto, and may be any type of related art as long as the driving assembly 200 can implement the above-described functions.

In the exemplary embodiment of the present disclosure, the drive assembly 200 is fixed to the substrate 100 via bolts and nuts.

In the exemplary embodiment of the present disclosure, as illustrated in FIG. 3, FIG. 4, and FIG. 5, the power delivery assembly 300 includes a driving rod 301, a driving gear 302, an idler 303, a transmission shaft 304, and a driven gear 305.

One end portion of the driving rod 301 is pivotably connected to the substrate 100, and the other end portion of the driving rod 301 is connected to the corresponding driving assembly 200.

The driving gear 302 is provided on the driving rod 301 and may rotate according to the rotation of the driving rod 301.

The idler 303 is pivotally connected to the substrate 100, and the idler 303 is meshed with the driving gear 302.

One end portion of the transmission shaft 304 is pivotably connected to the substrate 100, and the other end portion of the transmission shaft 304 is connected to the corresponding moving base 500. The transmission shaft 304 is provided coaxially with the moving base 500 which will be described later.

The driven gear 305 is provided on the transmission shaft 304, the driven gear 305 is meshed with the idler 303, and the transmission shaft 304 may rotate according to the rotation of the driven gear 305.

The driving force of the driving assembly 200 is transmitted to the transmission shaft 304 sequentially through the driving rod 301, the driving gear 302, the idler 303, and the driven gear 305 to drive the transmission shaft 304 to rotate the moving base 500 around an axis on which the transmission shaft 304 is located (that is, an axis on which the moving base 500 is located).

In the exemplary embodiment of the present disclosure, as illustrated in FIG. 5, the transmission shaft 304 includes a front extension portion 306 and a rear extension portion 307 connected to each other. Here, the rear extension portion 307 is pivotably connected to the substrate 100, and the driven gear 305 is provided between the front extension portion 306 and the rear extension portion 307.

In the exemplary embodiment of the present disclosure, the rail base 400 is generally cylindrical, and an interior of the rail base 400 is hollow to receive the moving base 500.

A receiving chamber 512 facing the substrate 100 corresponding to the transmission shaft 304 is provided in the moving base 500. A lug 308 is provided on one of an external circumferential surface of the front extension portion 306 and an internal circumferential surface of the receiving chamber 512, and a strip-shaped groove 513 that matches the lug 308 and extends in a front and rear direction is provided on the other of the external circumferential surface of the front extension portion 306 and the internal circumferential surface of the receiving chamber 512.

The lug 308 extends into the corresponding strip-shaped grooves 513 to cause the transmission shaft 304 to rotatably drive the moving base 500, and the lug 308 slide in the forward and rearward direction along the corresponding strip-shaped groove 513 so that the moving base 500 may linearly move in the forward and rearward direction thereof.

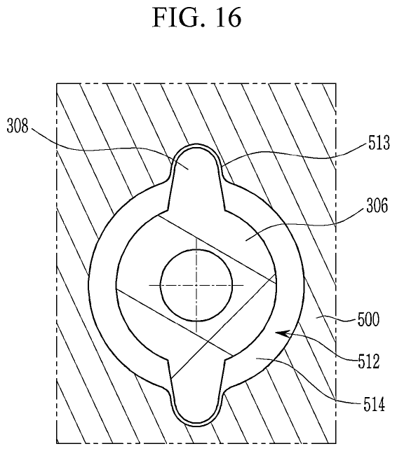

In the exemplary embodiment of the present disclosure, as illustrated in FIG. 16, the lug 308 is provided on the external circumferential surface of the front extension portion 306, and the strip-shaped groove 513 is provided on the internal circumferential surface of the receiving chamber 512.

In another exemplary embodiment of the present disclosure, the strip-shaped groove 513 is provided on the external circumferential surface of the front extension portion 306, and the lug 308 is provided on the internal circumferential surface of the receiving chamber 512.

In the exemplary embodiment of the present disclosure, as illustrated in FIG. 16, a gap 514 is formed between the external circumferential surface of the front extending portion 306 and the internal circumferential surface of the receiving chamber 512, and lubricating grease may be injected into the gap 514 to reduce frictional force and rattle noise when the transmission shaft 304 and the moving base 500 move in the forward and rearward direction relative to each other.

In the exemplary embodiment of the present disclosure, the rail base 400 is fixed to the substrate 100 via bolts and nuts.

In an exemplary embodiment exemplary embodiment of the present disclosure, as illustrated in FIG. 6, the guide groove 401 has a shape of closed loop.

The loop-shaped guide groove 401 forms a constant narrow angle with the vertical plane (see FIG. 6) to form a portion close to the substrate 100 (a portion farther from the human body) and a portion farther from the substrate 100 (that is, a portion close to the human body).

In another exemplary embodiment of the present disclosure, the guide groove 401 may have a closed shape other than the loop shape, for example, a closed wave shape.

When the guide groove 401 has a closed shape, the guide member 501 reciprocates along the guide groove 401 between the closest portion 403 closest to the substrate 100 (the portion farthest from the human body) and the remotest portion 404 farthest from the substrate 100 (that is, the portion closest to the human body) by the driving of the driving member 201 to guide the moving base 500 and the massage head member 600 to reciprocate.

In another exemplary embodiment of the present disclosure, the guide groove 401 may have an unclosed shape. For example, the guide groove 401 may be half of the loop-like shape forming the closed loop illustrated in FIG. 6. In the case where the guide member 501 of the moving base 500 slides to the remotest portion 404 of the guide groove 401 (that is, the portion closest to the human body) farthest from the substrate 100 and/or the closest portion 403 closest to the substrate 100 (that is, the portion farthest from the human body), when the controller 901 is configured to control the driving member 201 of the driving assembly 200 to rotate repeatedly while changing the direction, it is possible to implement the reciprocating motion of the moving base 500 and the massage head member 600.

In the exemplary embodiment of the present disclosure, at least one elastic member 701 is provided between each moving base 500 and the corresponding massage head member 600.

When the driver or occupant leans against the seatback (that is, applies force rearward toward the massage head member 600), the massage head member 600 applies load to the elastic member 701 so that the distance between the massage head member 600 and the moving base 500 becomes small, to provide elastic support and reduce feeling of irritation which may be felt during use.

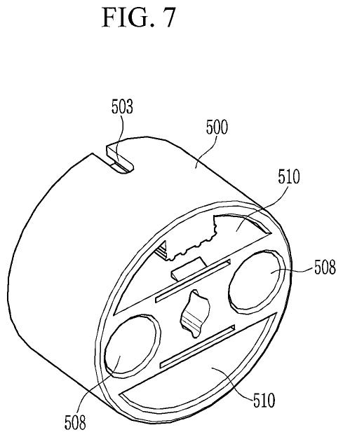

In the exemplary embodiment of the present disclosure, a fixing groove 503 is provided on the external circumferential surface of the moving base 500, and the guide member 501 is mounted into the corresponding fixing groove 503 through the fixing pin 504 and the fixing wedge 505 (see FIG. 5 and FIG. 7).

In the exemplary embodiment of the present disclosure, the guide member 501 includes a bearing 506 and a rotation shaft 507.

The bearing 506 is mounted in the fixing groove 503.

The rotation shaft 507 is mounted on an internal ring of the bearing 506, and the rotation shaft 507 may rotate relative to the bearing 506 (see FIGS. 3, 5 and 8).

When the bearing 506 and the rotation shaft 507 are integrated with each other, the guide member 501 may generate sliding frictional force with the guide groove 401 during operation. The rotation shaft 507 according to the exemplary embodiment of the present disclosure together with the bearing 506 rotates about the rotating axis on which the transmission shaft 304 is located (that is, the axis on which the moving base 500 is located), and at a same time, the rotation shaft 507 rotates relative to the bearing 506, so that in the massage process, the rotation shaft 507 and the guide groove 401 generate rolling frictional force. The rolling frictional force is smaller than the aforementioned sliding frictional force, so that wear on the guide groove 401 and the guide member 501 may be reduced.

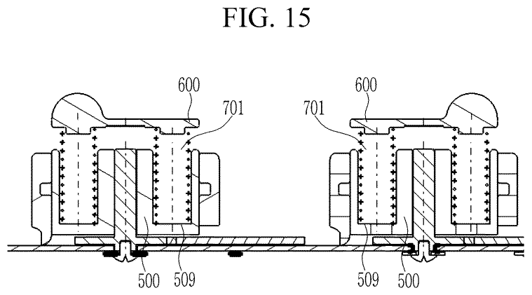

In the exemplary embodiment of the present disclosure, the moving base 500 is provided with a mounting groove 508 toward the massage head member 600 (see FIG. 7), and one end portion of each elastic member 701 is connected to a bottom wall 509 of the corresponding mounting groove 508 (see FIG. 15), and the other end portion of each elastic member 701 is connected to the corresponding massage head member 600.

In an exemplary embodiment exemplary embodiment of the present disclosure, the moving base 500 is provided with two mounting grooves 508 toward the massage head member 600 (see FIG. 7).

The number of the mounting grooves 508 may be adjusted according to circumstances. For example, the number of the mounting grooves 508 may be set to 1 to 6.

In the exemplary embodiment of the present disclosure, at least one sliding groove 510 toward the massage head member 600 is provided in the moving base 500.

In an exemplary embodiment exemplary embodiment of the present disclosure, the moving base 500 is provided with two sliding grooves 510 (refer to FIG. 5 and FIG. 7).

The number of the sliding grooves 510 may be adjusted according to circumstances. For example, the number of the sliding grooves 510 may be set to 1 to 6.

In the exemplary embodiment of the present disclosure, the massage head member 600 includes a massage head member main body 601, an insertion connecting member 602, and a projection 603 (see FIGS. 3 and 5).

The insertion connecting member 602 extends from the massage head member main body 601 toward one side close to the substrate 100. The massage head member main body 601 is mounted on the moving base 500 so that the insertion connecting member 602 is inserted into the corresponding sliding groove 510 and linearly moves in the forward and rearward direction along the sliding groove 510 (see FIG. 5). Accordingly, the insertion connecting member 602 may cause the massage head member main body 601 to linearly move in the forward and rearward direction with respect to the moving base 500.

The protrusion 603 protrudes from the massage head member main body 601 toward one side away from the substrate 100 (refer to FIG. 5), and performs the massage.

The user controls each of the massage head members 600 by controlling each of the driving assemblies 200 by the controller 901 to allow the plurality of massage head members 600 to operate asynchronously, so that various massage modes are provided.

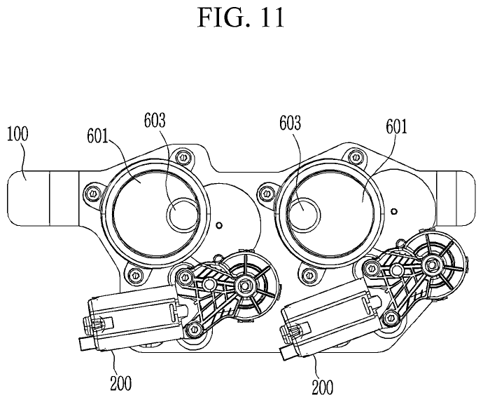

For example, when the controller 901 is configured to control the two drive assemblies 200 to rotate, the two massage head member main bodies 601 may synchronously rotate the respective protrusions 603 in opposite directions about the axes of the respective massage head member main bodies 601. Accordingly, the controller 901 causes the two protrusions 603 to rotate symmetrically (refer to FIGS. 4 and 11).

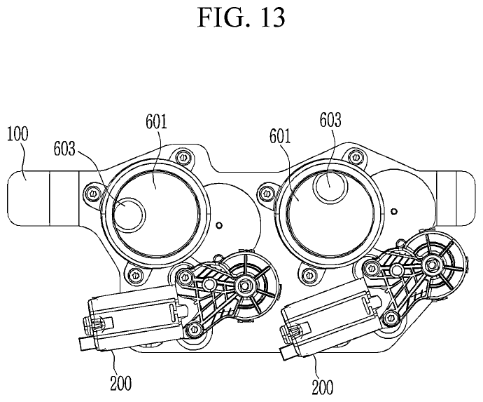

In another example, when the controller 901 control the operation of the two drive assemblies 200, the two protrusions 603 are located at different positions which are independent from each other (see FIG. 13).

The greater the number of the massage head members 600 is, the greater the number of the combinable massage modes is.

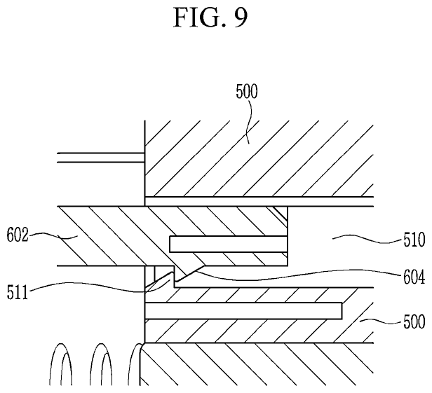

In the exemplary embodiment of the present disclosure, as illustrated in FIGS. 5 and 9, a first elastic buckle 511 is provided on the internal surface of the sliding groove 510, and a second elastic buckle 604 matching the first elastic buckle 511 is provided on the external surface of the insertion connecting member 602. The insertion connecting member 602 may be inserted into the sliding groove 510 while the second elastic buckle 604 passes through the first elastic buckle 511 and is locked by the first elastic buckle 511, and the massage head member 600 is prevented from being separated from the moving base 500 by preventing the insertion connecting member 602 from being separated from the sliding groove 510.

In the exemplary embodiment of the present disclosure, a felt 702 is provided between the massage head member main body 601 and the moving base 500 (see FIG. 3) to reduce contact noise.

According to the exemplary embodiment of the present disclosure, the vehicle is provided with the seat massage system.

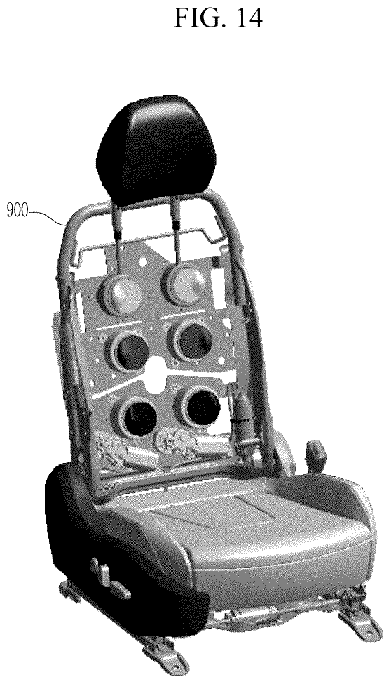

The seatback may be provided with two massage head members 600 (see FIG. 1) or six massage head members 600 (see FIG. 14), and the number of massage head members 600 may be adjusted according to circumstances.

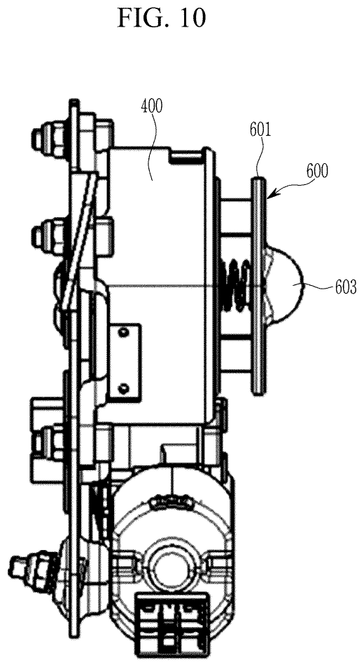

In an exemplary embodiment exemplary embodiment of the present disclosure, the massage head member 600 is located at the position farthest from the human body (see FIG. 10) (that is, the initial position). When the driver or an occupant leans on the seatback, the massage head member 600 elastically supports the occupant constantly along an axial direction, preventing the feeling of irritation.

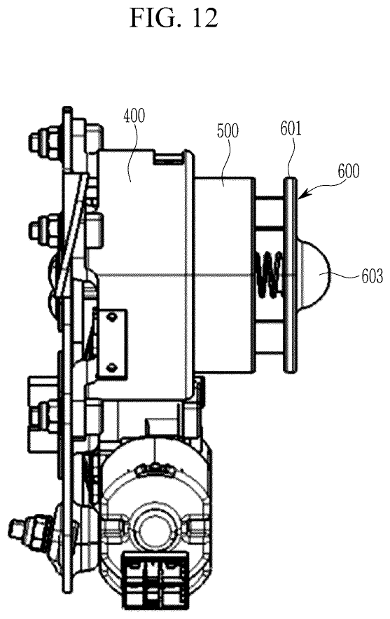

When the support function is activated, through the coupling of the sensor 402 and the magnetic member 502, the controller 901 stops the protrusion 603 at a foremost position (that is, the position closest to the human body) (refer to FIG. 12) to support the waist or the rear of the user.

When the massage function is activated, the plurality of massage head members 600 start to move synchronously or intermittently for a predetermined distance in the axial direction under the control of the controller, providing a plurality of massage modes.

To better interpret and precisely define the appended claims, terms “top”, “bottom”, “inside”, “outside”, “upper surface”, “lower surface”, “of the upper surface”, “of the lower surface”, to the top”, “to the bottom”, “front”, “back”, “behind”, “inside”, “outside”, “to the inside”, “to the outside”, “inner side”, “external side”, “of the inside”, “of the outside”, “forward”, and “backward” are for describing the features of the exemplary embodiment with reference to the locations of these features illustrated in the drawings.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A seat massage system, comprising:
a substrate configured to be mounted on a seatback frame;
at least one drive assembly mounted on the substrate;
at least one power delivery assembly mounted on the substrate and receiving driving force from a corresponding driving assembly;
at least one rail base mounted on the substrate and including a guide groove provided on an internal surface of the at least one rail base, the guide groove including a first portion close to the substrate and a second portion farther from the substrate;
at least one moving base, each being provided on a corresponding rail base to receive the driving force from a corresponding power delivery assembly, and provided with a guide member corresponding to the guide groove of the at least one rail base, the guide member extending into the guide groove and sliding along the guide groove; and
at least one massage head member provided at a front end portion of a corresponding moving base.
wherein the at least one power delivery assembly drives the corresponding moving base to rotate relative to the at least one rail base by driving of the at least one drive assembly, and at a same time causes the at least one moving base to linearly move in a forward and rearward direction through coupling of the guide member and the guide groove, and controls the at least one moving base to stop at a predetermined position thereof.

2. The seat massage system of claim 1,
wherein a sensor is provided on one of the at least one rail base and the corresponding moving base, and a magnetic member matching the sensor is provided on another of the at least one rail base and the corresponding moving base, and
wherein the magnetic member is aligned with the sensor when the guide member slides along the guide groove to a closest portion of the guide groove closest to the substrate and/or a remotest portion of the guide groove farthest from the substrate.

3. The seat massage system of claim 2, further including a controller,
wherein when the magnetic member is aligned with the sensor, the sensor generates a trigger signal and sends the trigger signal to the controller, and the controller is configured to control the corresponding driving assembly according to the trigger signal to stop the at least one moving base and the at least one massage head member at predetermined positions.

4. The seat massage system of claim 2, wherein the guide groove has a shape of closed loop.

5. The seat massage system of claim 4, wherein at least one elastic member is provided between the at least one moving base and a corresponding massage head member.

6. The seat massage system of claim 1, wherein a fixing groove is provided on an external circumferential surface of the at least one moving base, and the guide member is mounted in a corresponding fixing groove through a fixing pin and a fixing wedge.

7. The seat massage system of claim 6, wherein the guide member includes:
a bearing mounted in the fixing groove; and
a rotation shaft mounted on an internal ring of the bearing and rotating relative to the bearing.

8. The seat massage system of claim 5, wherein the at least one moving base is provided with a mounting groove toward the at least one massage head member, a first end portion of the at least one elastic member is connected to a bottom wall of the mounting groove, and a second end portion of the at least one elastic member is connected to the corresponding massage head member.

9. The seat massage system of claim 1, wherein at least one sliding groove toward the at least one massage head member is provided on the at least one moving base.

10. The seat massage system of claim 9, wherein the at least one massage head member includes:
a massage head member main body;
an insertion connecting member which extends from the at least one massage head member main body toward one side close to the substrate, and allowing the at least one massage head member main body to linearly move in the forward and rearward direction with respect to the at least one moving base, the at least one massage head member main body being mounted to the at least one moving base so that the insertion connecting member is inserted into a corresponding sliding groove and linearly moves in the forward and rearward direction along the corresponding sliding groove; and
a protrusion protruding from the at least one massage head member main body toward one side away from the substrate.

11. The seat massage system of claim 10, wherein a felt is provided between the at least one massage head member main body and the at least one moving base.

12. The seat massage system of claim 1, wherein the at least one power delivery assembly includes:
a driving rod including a first end portion pivotably connected to the substrate and a second end portion connected to the corresponding driving assembly;
a driving gear provided on the driving rod and being rotatable according to a rotation of the driving rod;
an idler pivotally connected to the substrate and meshed with the driving gear;
a transmission shaft including a first end portion pivotably connected to the substrate and a second end portion connected to the corresponding moving base; and
a driven gear provided on the transmission shaft and meshed with the idler, the transmission shaft being rotatable according to a rotation of the driven gear.

13. The seat massage system of claim 12,
wherein the transmission shaft includes a front extension portion and a rear extension portion connected to each other,
wherein the rear extension portion is pivotally connected to the substrate, and
wherein the driven gear is provided between the front extension portion and the rear extension portion.

14. The seat massage system of claim 13,
wherein the at least one moving base is provided with a receiving chamber facing the substrate corresponding to the transmission shaft, a lug is provided on one of an external circumferential surface of the front extension portion and an internal circumferential surface of the receiving chamber, and a strip-shaped groove that extends in the forward and rearward direction and matches the lug is provided on another of the external circumferential surface of the front extension portion and the internal circumferential surface of the receiving chamber, and
wherein the lug extends into the strip-shaped groove to cause the transmission shaft to rotatably drive the at least one moving base, and the lug slides in the forward and rearward direction along the strip-shaped groove so that the at least one moving base linearly moves in the forward and rearward direction.

15. A vehicle provided with the seat massage system of claim 1.
